(19) United States
(12) Patent Application Publication
(10) Pub. No.: US 2003/0145799 A1
(43) Pub. Date: Aug. 7, 2003

(54) Animal enclosure system

(76) Inventors: Rodger Hays, Columbus, OH (US); Elmer J. Chatin, Fredericktown, OH (US); Mark A. Zellefrow, Reynoldsburg, OH (US)

Correspondence Address: Thompson Hine LLP, 10 W. Broad St., Suite 700, Columbus, OH, 43215-3435, US

(21) Appl. No.: 10/341,077

(22) Filed: Jan. 13, 2003

Related U.S. Application Data
(60) Provisional application No. 60/347,992, filed on Jan. 14, 2002.

(51) Int. Cl. A01K 1/02; A01K 3/00

(52) U.S. Cl. 119/502

(57) ABSTRACT

An animal enclosure system is disclosed utilizing a coated metal wire grid mounted within a frame formed of horizontal and vertical support members. The end of each wire on the wire grid has a captive termination that allows the wire grid to be installed into an opening, hole, or channel of the support members. The wire grid may also incorporate a hinge area formed by dividing the horizontal wires into two portions and wrapping the inner terminating points around a particular perpendicular vertical wire near the mid-point of the body of the wire grid. The hinge allows the wire grid to be folded, facilitating easier handling, storage and transport of the enclosure in its disassembled state. When the wire grid is assembled with the support members, along with corner pieces, it forms a single panel of the animal enclosure.

This application claims the benefit of U.S. Provisional Patent Application No. 60/347992, filed Jan. 14, 2002.

### FIELD

This invention relates to animal enclosures. In particular, the invention relates to an animal enclosure system having interlocking components.

### BACKGROUND OF THE INVENTION

Prior art animal enclosures such as dog kennels are generally made from heavy galvanized steel support posts and frames, and large sections of chain link fencing. The chain link fencing is typically attached to the metal frames by means of a variety of burdensome clamping devices, clips and ties, most of which require tools to cut to size and secure. The frames are in turn attached to the support posts to form the enclosure. Most of the prior art chain link fencing sections are 10 feet wide by 6 feet high, making them quite heavy and awkward to handle, store and transport.

Aesthetically, the prior art enclosures can be an eyesore, being made with a silver or gray galvanized finish. The galvanized finish is subject to weathering, requiring the user to periodically re-coat the enclosure to prevent rusting. Even with regular re-coating, the many clamping devices, clips and ties are prone to corrosion, making maintenance and repair of the enclosure difficult and time-consuming.

Finally, the designs of the prior art enclosures generally have sharp edges at the extents of the chain link where the wires that form the chain link terminate. Also, edges of the chain link fencing can extend beyond the frame and are generally exposed. These sharp edges present a risk of injury to both animals and humans.

There is a need for an animal enclosure that is easier to handle, store, and transport. In addition, there is a need for an animal enclosure that is more easily installed and uninstalled, has improved durability and is more aesthetically pleasing. Lastly, there is a need for an animal enclosure that is safer for animals and humans.

### SUMMARY

An animal enclosure system is disclosed comprising a series of side panels constructed from a coated metal wire grid for fencing material mounted within a frame formed of horizontal and vertical support members. The wire grid has an overlapping orthogonal pattern of parallel vertical wires and parallel horizontal wires. The outer ends of each wire in the wire grid is terminated in a captive termination such as a loop, bend or device that allows the outer ends of the wire grid to be installed into corresponding openings, holes, or longitudinal channels within the support members. The wire grid may also incorporate a hinge area formed by dividing the horizontal wires into two portions and wrapping the inner terminating points around an appropriate perpendicular vertical wire near the mid-point of the body of the wire grid. The hinge allows the wire grid to be folded, facilitating easier handling, storage and transport of the enclosure in its disassembled state. When the wire grid is assembled with the support members, along with corner pieces, it forms a single panel of the animal enclosure. The wire grid may be much smaller than currently available animal enclosures, such as 5 feet wide by 6 feet high, which is about half the width of prior art chain link fencing material. As a result, the components of the present invention are lighter and smaller, making them easier to handle, assemble, store and transport.

### BRIEF DESCRIPTION OF THE DRAWINGS

FIG. 1 is an elevational view of a typical prior art animal enclosure;

FIG. 2 illustrates a wire grid portion of the animal enclosure according to an embodiment of the present invention;

FIG. 3 is an expanded view of the wire grid of FIG. 2 showing the hinge area and one means for terminating the wire end portions;

FIG. 4A is an end view of a support member and captive termination according to one embodiment of the present invention;

FIG. 4B is an end view of a support member and captive termination according to an alternate embodiment of the present invention;

FIG. 4C is an end view of a support member and captive termination according to another alternate embodiment of the present invention;

FIG. 4D is an end view of a support member and captive termination according to yet another embodiment of the present invention;

FIG. 4E is an end view of a support member having opposing engageable openings according to still another embodiment of the present invention;

FIG. 5 is an illustration of a side panel of the animal enclosure with the wire grid mounted within a frame according to an embodiment of the present invention;

FIG. 6 is an exploded view showing the assembly of one of the upper corners according to an embodiment of the present invention;

FIG. 7 is an exploded view showing the assembly of one of the lower corners according to an embodiment of the present invention;

FIG. 8 shows the attachment of the wire grid to the support member according to a preferred embodiment of the present invention;

FIG. 9 illustrates a hinged entry panel according to an embodiment of the present invention; and

FIG. 10 shows an example of a complete assembly of an animal enclosure according to an embodiment of the present invention.

### DESCRIPTION OF THE PREFERRED EMBODIMENT(S)

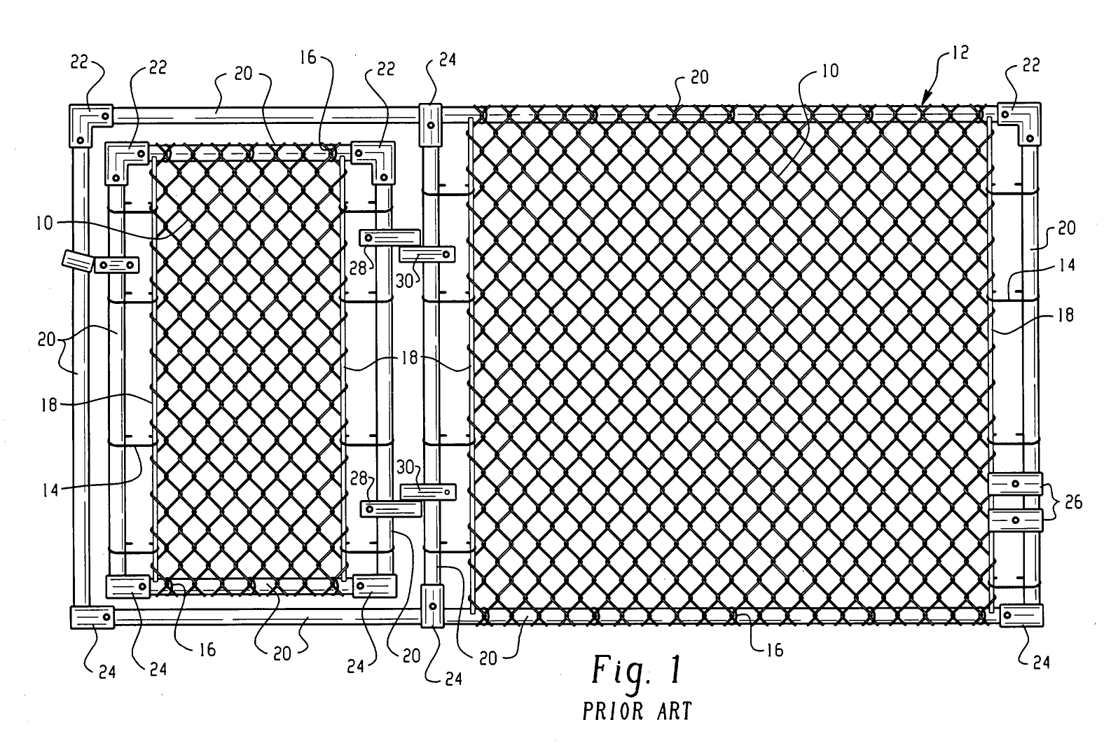

An elevational view of a section of a typical prior art animal enclosure, such as a dog kennel, is shown in FIG. 1. A section of chain link fencing 10 is secured within a frame 12 by a plurality of clips 14, hook ties 16 and tension rods 18. The frame 12 may be assembled using a plurality of pipes 20, corners 22, brace clamps 24, kennel clamps 26, male hinges 28 and female hinges 30. The multitude of parts makes the animal enclosure time-consuming and burdensome to construct, and costly for manufacturers and sellers to package and ship. In addition, the ends of the chain link 10 extend beyond the frame 12, exposing the sharp edges of the chain link to contact by animals and humans.

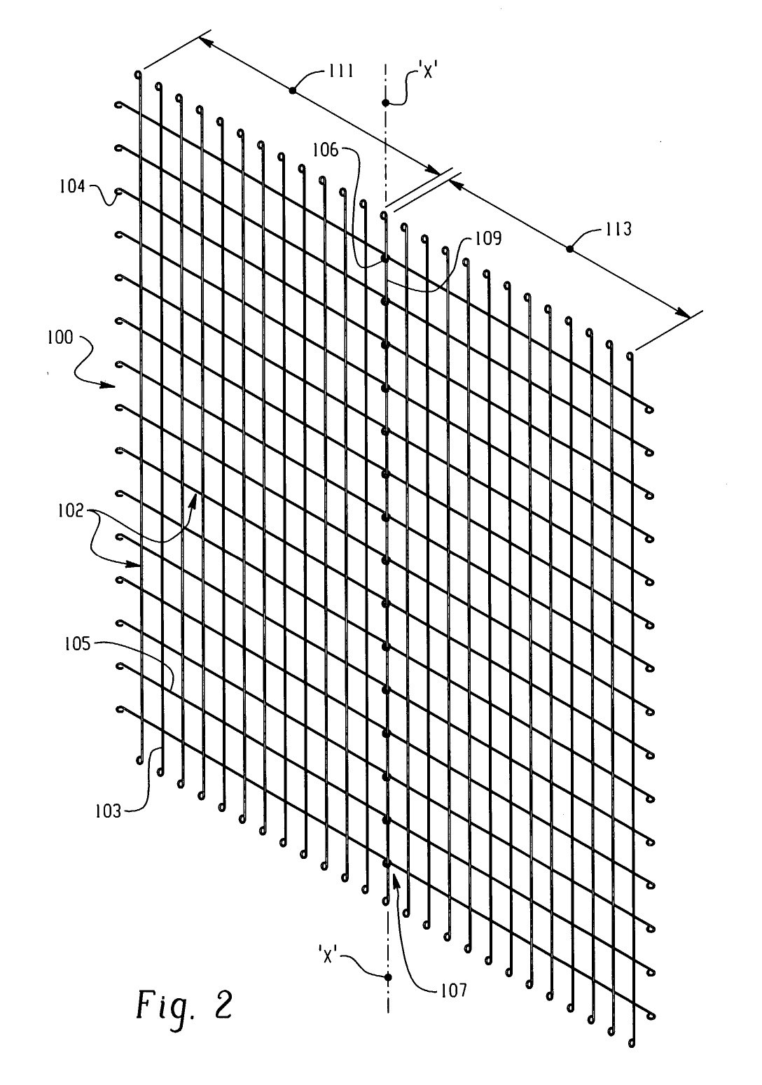

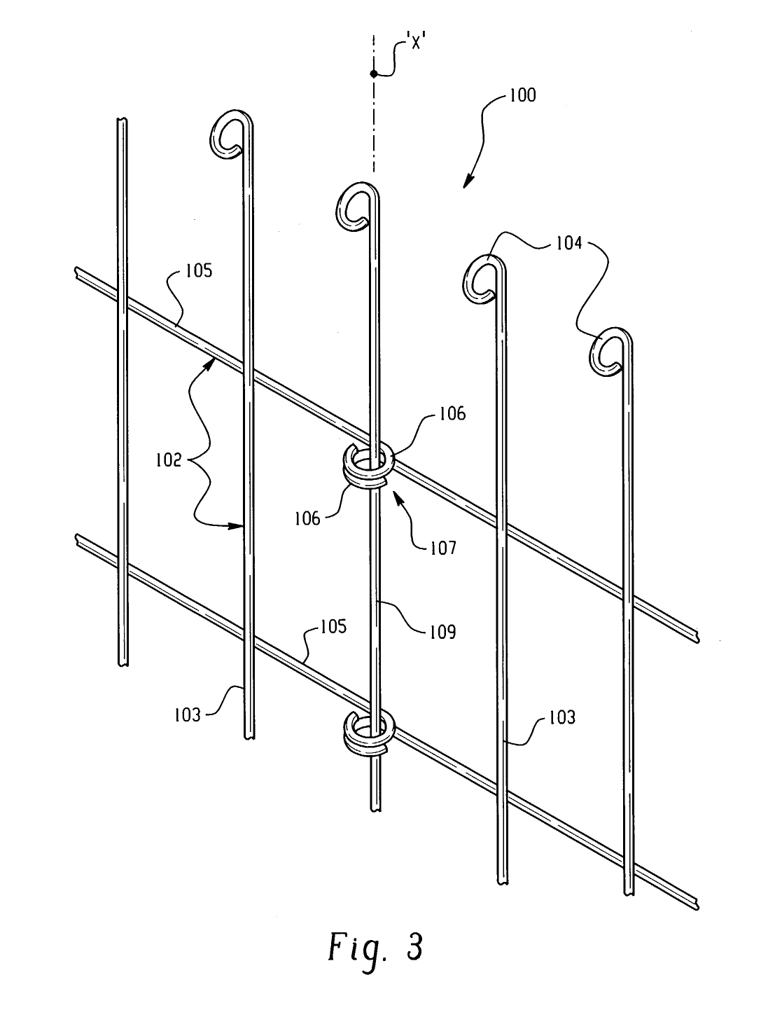

FIG. 2 shows a wire grid 100 constructed according to one embodiment of the present invention. The body portion of the wire grid 100 is formed into a generally rectangular shape using wire 102 in an overlapping pattern. In a preferred embodiment a plurality of generally parallel, vertically-oriented wires 103 orthogonally overlap a plurality of generally parallel, horizontally-oriented wires 105. However, the overlapping wires 103,105 may be oriented at angles other than vertical and horizontal within the wire grid 100. Further, the wires 103,105 may overlap each other orthogonally or at an angle. The wires 103,105 may or may not be coupled together at the intersecting points of wires 103,105. Example means of coupling the intersecting points of wires 103,105 include, but are not limited to, welding, cementing, fastening, tying, clamping, interlacing, weaving, looping and molding. The wire 102 may be metal with a protective coating such as epoxy, powder-coating, plastic or any other suitable material. The end portions of the wires 103,105 are terminated into a plurality of captive terminations 104 such as loops, bends or hardware attachments designed to secure the wire grid 100 within support members (discussed below). A hinge 107 may be formed about an axis “X” by dividing the horizontal wires 105 into two portions and shaping the interior ends of the horizontal wires into hinge loops 106. The hinge loops 106 are wrapped around a particular vertical wire 109 to form the hinge 107. The hinge 107 allows the left and right portions 111,113 of the wire grid 100 to be folded into facial engagement to make the wire grid section more compact for ease of handling, storage or transport. The hinge 107 may be located near the center of the wire grid 100. In other alternate embodiments the hinge 107 may be located in a position offset from the center of the wire grid 100 and/or more than one hinge may be employed. In still another alternate embodiment (not shown), the hinge 107 may be oriented horizontally wherein the hinge is formed by wrapping hinge loops as at 106 of vertical wires around a common horizontal wire. An expanded view of the wire grid 100 and hinge 107 is shown in FIG. 3. In this figure the captive terminations 104 are embodied as loops formed at an angle of about 90 degrees in relation to a plane formed by the body portion of the wire grid 100.

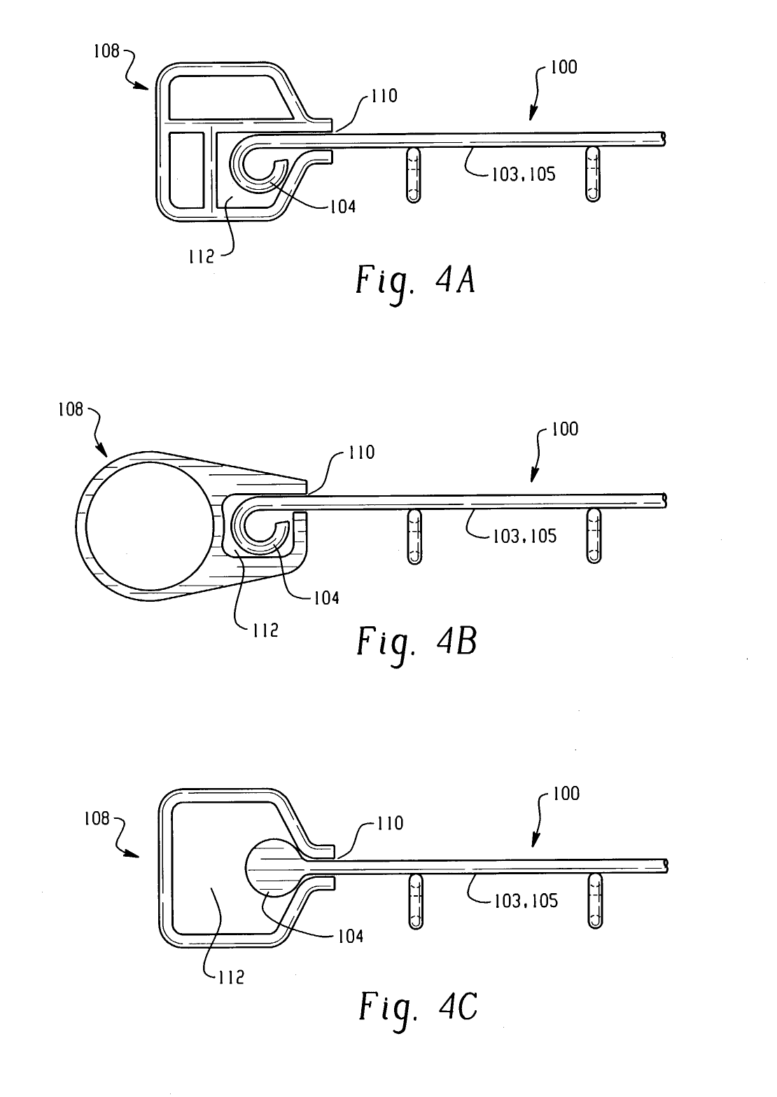

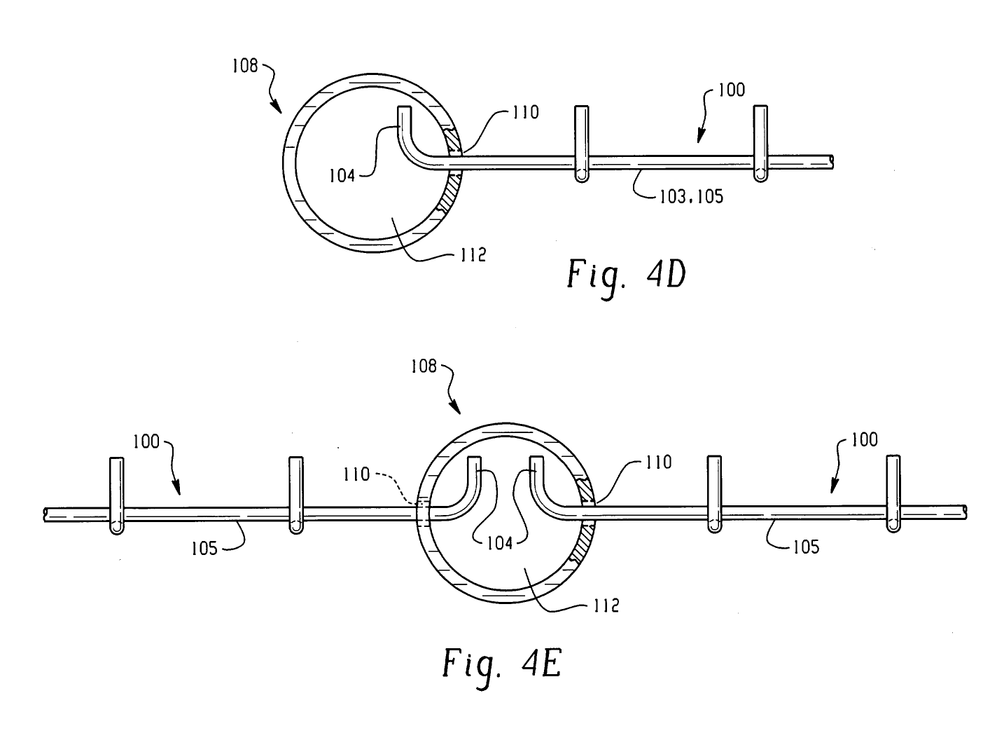

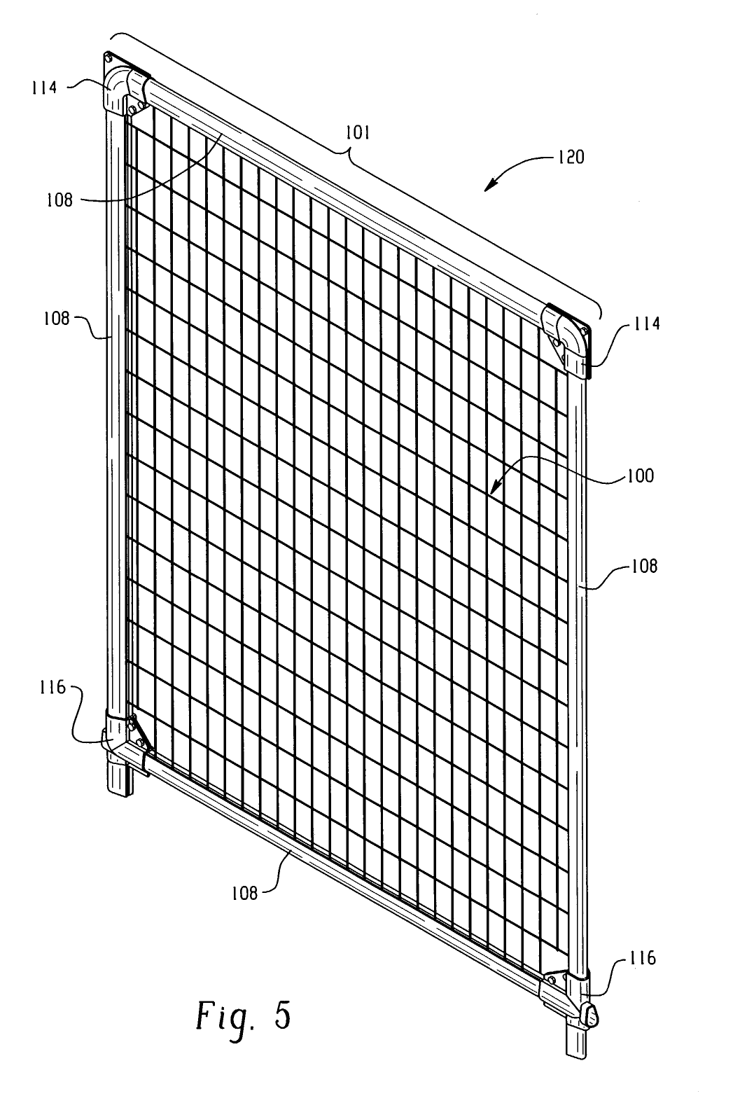

With reference to FIGS. 4A-E and FIG. 5 in combination, vertically and horizontally oriented support members as at 108 are used to provide a structural support frame 101 for the wire grid 100. End views of a support member 108 according to various example embodiments of the present invention are shown in FIGS. 4A-D along with some example embodiments of the captive terminations 104. The support members 108 may be made from any suitable material such as plastic, composites or metal. The support members 108 have along the longitudinal axis one or more engageable openings 110, such as a continuous channel or a plurality of holes, and a cavity 112. The wire grid 100 is positioned such that the captive terminations 104 engage with the cavity 112 of the support members 108 and the wires 103,105 extend into the engageable openings 110, thereby captively retaining the terminations 104 inside the cavity 112 and securing the wire grid 100 within the frame 101 of assembled support members to form a section 120. By captively retaining the terminations 104 inside the cavities 112 of the support members 108, no added retaining hardware is needed and the sharp edges of the chain links found in the prior art animal enclosures are eliminated. The present invention also allows for quicker assembly of the animal enclosure, produces a more rigid panel assembly, and reduces the amount of hardware required to attach the wire grid to the support members as compared to the prior art.

An alternative embodiment of the support member 108 is shown in FIG. 4E wherein at least one vertically oriented support member is provided with opposing engageable openings 110 along the longitudinal axis. The opposing engageable openings 110 correspond to the captive terminations 104 of the wire grid 100 such that the captive terminations 104 engage with the cavity 112 and the horizontal wires 105 extend into the engageable openings 110, thereby captively retaining the terminations 104 inside the cavity 112. The opposing engageable openings 110 of the vertically oriented support member 108 provide support for two adjacent wire grids 100. Any of the embodiments depicted in FIGS. 4A-D may optionally have opposing engageable openings 110, if desired.

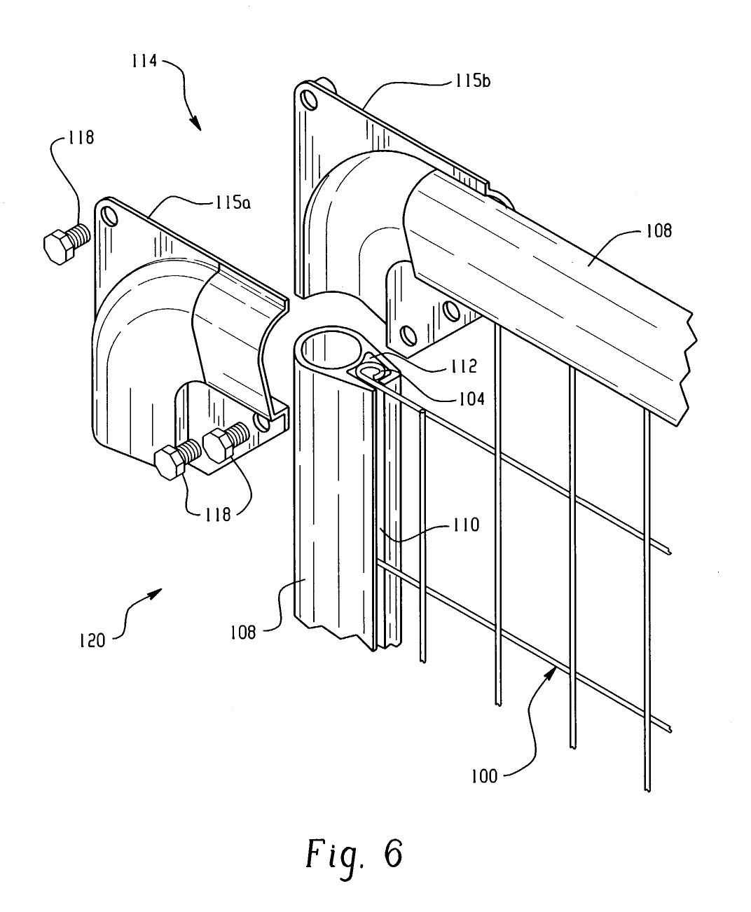

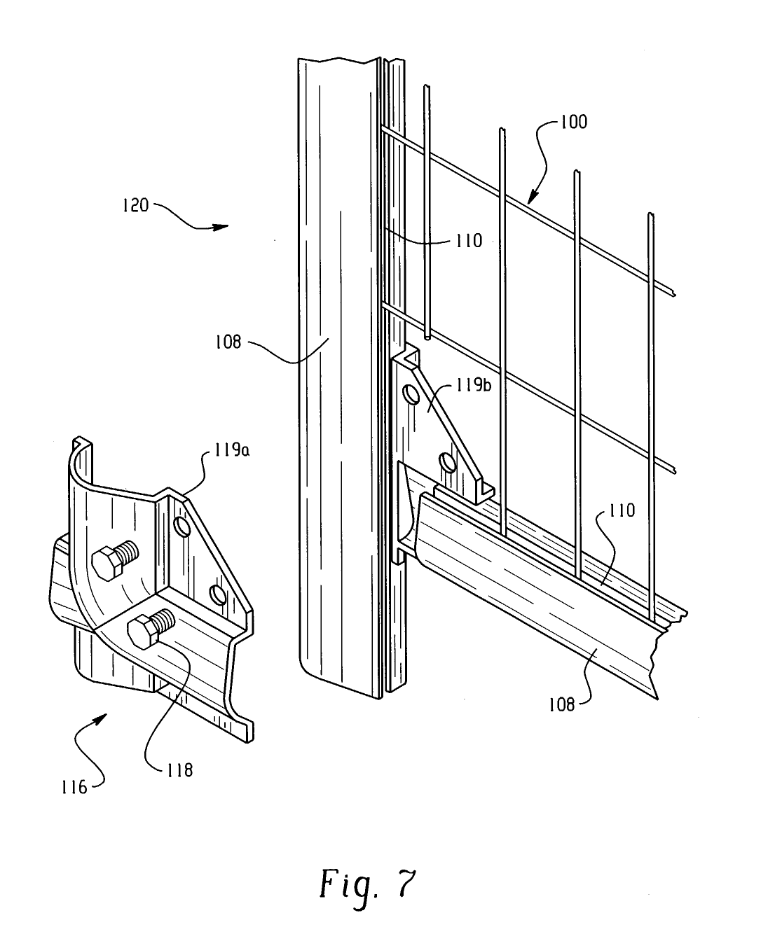

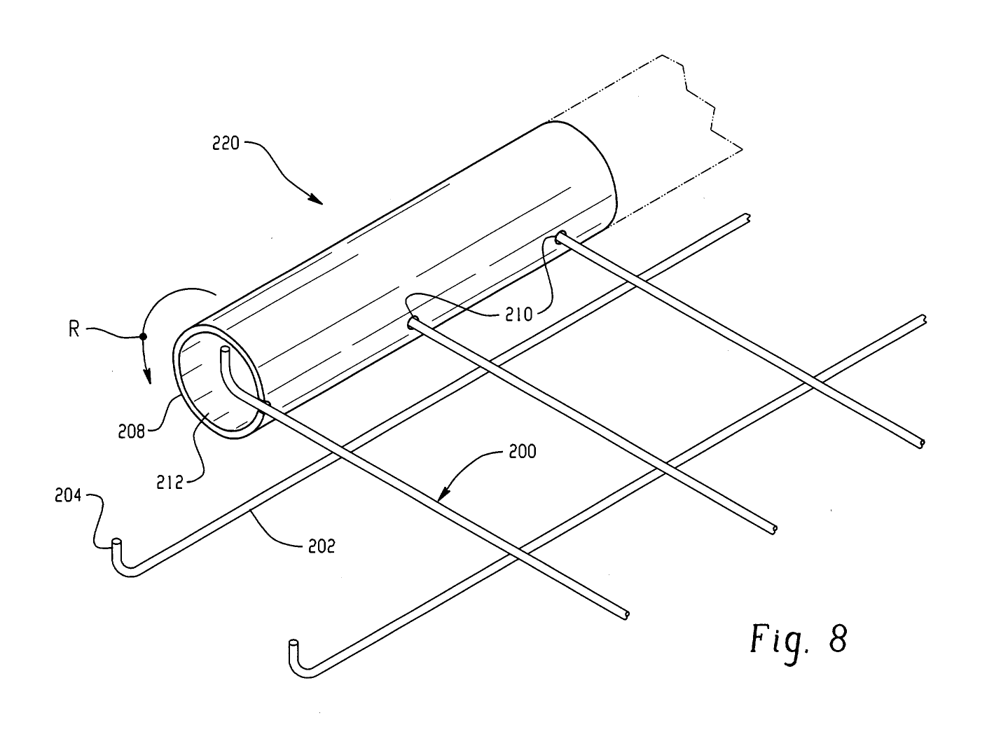

After the wire grid 100 is attached to the horizontally and vertically oriented support members 108, a section or side panel 120, may be formed by adding upper corners 114 and lower corners 116 as shown in FIG. 5. The upper corners 114 may be formed from symmetrical halves 115a,115b and secured together with suitable fasteners 118, as shown in FIG. 6. The upper corners 114 may conform to the profile of the support members 108 to give a clean, finished appearance to the intersections of vertically and horizontally oriented support members. In addition, the upper corners 114 may be moisture resistant to minimize water intrusion into the support members 108. Likewise, the lower corners 116 may be formed from symmetrical halves 119a,119b and secured together with suitable fasteners 118 as shown in FIG. 7. The lower corners 116 may be constructed in such a manner to allow the vertically oriented support members 108 to extend below the lower corners to provide ground clearance for the lower horizontal support member 108. This allows the assembled side panel 120 to be conveniently attached to another surface such as a pad or floor and also allows for debris in the animal enclosure to be hosed out under the bottom horizontal support member 108. The upper and lower corners 114,116 may be made from any suitable material such as metal, composites or plastic.

A preferred embodiment of a section 220 of the present invention is partially shown in FIG. 8. A support member 208 is formed with a plurality of engageable openings 210 and a cavity 212 along the longitudinal axis. The engageable openings 210 extend from the outside surface of the support member 208 into the cavity 212. Captive terminations 204 are preferably bends formed on the ends of the wires 202 of a wire grid 200, although other captive means are envisioned. The captive terminations 204 may be formed at an angle of about 90 degrees in relation to a plane formed by the body portion of the wire grid 200. A corresponding support member 208 is positioned in alignment over the captive terminations 204 such that the captive terminations are simultaneously inserted into the corresponding engageable openings 210. Once the captive terminations 204 are fully inserted into the engageable openings 210, the support member 208 may be partially rotated in a direction “R” in relation to the body portion of the wire grid 200, engaging the wire grid with the support member. Support members 208 may be similarly attached to the remaining edges of the wire grid 200. A side panel 220 may then be assembled using upper and lower corners 114,116 and fasteners 118 as previously described. By inserting the captive terminations 204 into the engageable openings 210, the sharp edges found in the prior art animal enclosures are eliminated. The present invention also allows for quicker assembly of the animal enclosure, produces a more rigid panel assembly, and reduces the amount of hardware required to attach the wire grid to the support members as compared to the prior art.

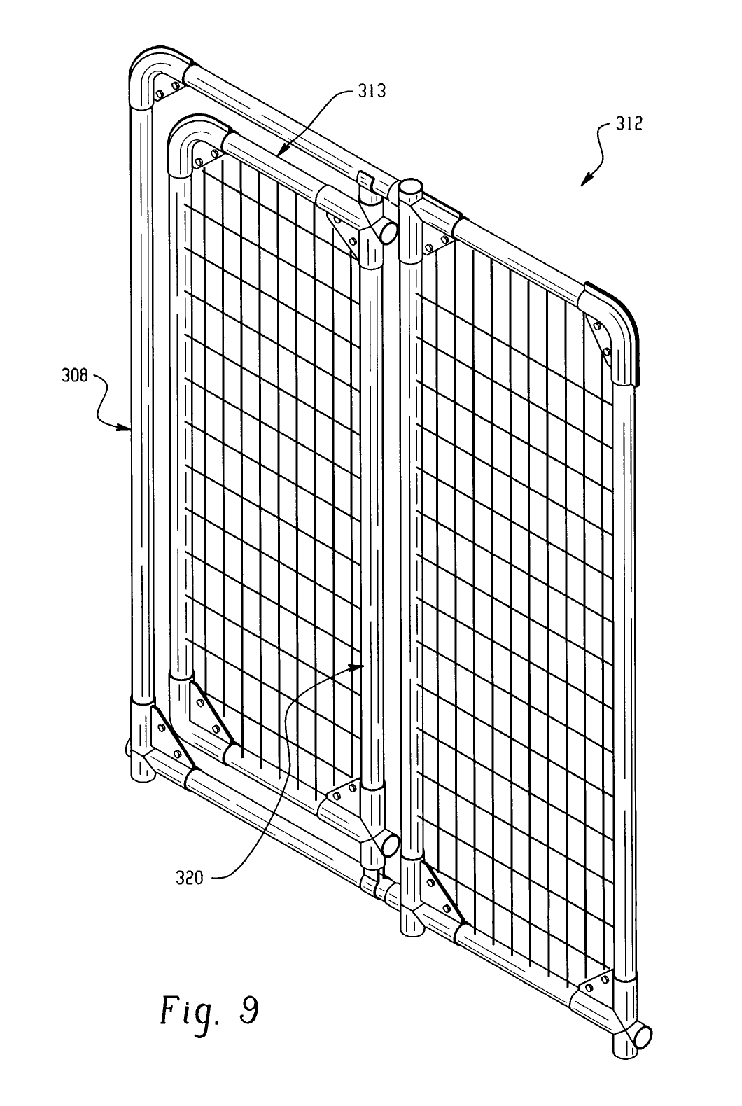

FIG. 9 shows an access panel 313 within a side panel 312 that may be used with the present invention. The access panel 313 is attached to a rotating post 320 which acts as a hinge for opening and closing the access panel 313. The access panel 313 may be configured to open either inwardly or outwardly. Alternatively, access panel 313 may be configured to open only outwardly or only inwardly, as desired. A latch (not shown) engageable with a stationary frame member 308 may be used to secure the access panel 313 in a closed position.

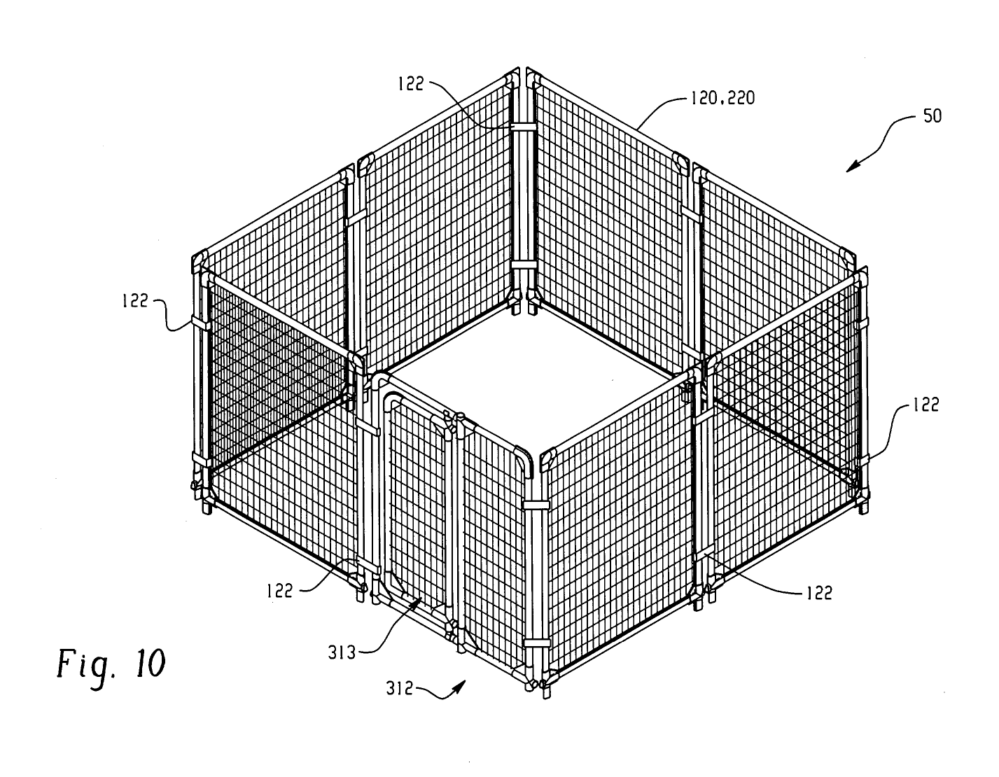

FIG. 10 shows how a plurality of side panels 120 or 220 may be arranged to form a complete animal enclosure 50 such as a dog kennel, according to one embodiment of the invention. The sections 120 or 220 may be arranged into any shape desired, such as a rectangle or square. A larger quantity of side panels may be arranged to form more complex shapes, such as “L” and “U” shaped enclosures. A plurality of section connectors 122 are placed between the vertical support members 108 of adjacent sections 120,220 together to form a rigid enclosure. FIG. 10 also illustrates a side panel 312 having an access panel 313.

According to the embodiments, the animal enclosure may be provided to consumers in pre-constructed form. Alternatively, the enclosure may be supplied as a kit to be constructed by the consumer. By reducing the size and number of components, the enclosure may be more easily handled, stored or transported. In addition, the coated wiring and enclosed grid wire ends make the enclosure more aesthetically pleasing and less susceptible to weathering.

While the present invention has been described with respect to certain specific examples, it will be apparent that many modifications and variations are possible without departing from the scope of the following claims and that the enclosure may be used or adapted for use for other purposes than solely for the containment of animals. For example, the present invention may be used to prevent access by animals to a certain area, such as a garden. Likewise, the enclosure system may be used to create a restricted area, such as a tool crib.

What is claimed is:

1. An animal enclosure system, comprising:
a plurality of side panels, comprising:
a rectangular wire grid having a body portion and end portions, the body portion comprising a plurality of overlapping wires and the end portions having captive terminations;
a plurality of support members having an internal cavity along a longitudinal axis and at least one engageable opening corresponding to the captive terminations, the engageable opening beginning at an external surface along the longitudinal axis and ending in the cavity, the support members being oriented horizontally and vertically such that the engageable opening aligns with and engages the captive terminations of the wire grid;
a pair of upper corners coupled to the upper proximal ends of the horizontal and vertical support members;
a pair of lower corners coupled to the lower proximal ends of the horizontal and vertical support members; and
a plurality of section connectors placed between the vertically oriented support members of adjacent side panels to couple the adjacent side panels together.

2. The animal enclosure system of claim 1 wherein at least one side panel further comprises a hingedly attached access panel.

3. The animal enclosure system of claim 1 wherein the wire grid has a central hinged area.

4. The animal enclosure system of claim 1 wherein the grid wires are coated with epoxy.

5. The animal enclosure system of claim 1 wherein the end portions of the wire grid are captive terminated in bends having an angle of about 90 degrees in relation to the body portion of the wire grid and the engageable opening of the support members comprises a plurality of holes.

6. The animal enclosure system of claim 1 wherein the end portions of the wire grid are captive terminated in loops at an angle of about 90 degrees in relation to the body portion and the engageable opening of the support members comprises a channel.

7. The animal enclosure system of claim 1 wherein the end portions of the wire grid are captive terminated in hardware attachments and the engageable opening of the support members comprises a channel.

8. The animal enclosure system of claim 1 wherein the vertically oriented support members extend below the lower corners to touch a ground or floor surface such that the lower horizontally oriented support member is positioned above the ground or floor surface.

9. The animal enclosure system of claim 1 wherein the support members are made of plastic.

10. The animal enclosure system of claim 1 wherein the support members are made of metal.

11. The animal enclosure system of claim 1 wherein the upper corners are moisture resistant.

12. The animal enclosure system of claim 1 wherein the upper and lower corners conform to the profile of the support members.

13. The animal enclosure system of claim 1 wherein the side panels are arranged to form a rectangular shape.

14. The animal enclosure system of claim 1 wherein at least one vertical support member is provided with opposing engageable openings along its longitudinal axis, the engageable openings corresponding to the captive terminations of two wire grids.

15. The animal enclosure system of claim 1 wherein the overlapping wires of the wire grid are oriented generally vertically and horizontally, and overlap orthogonally.

16. An animal enclosure system, comprising:
a plurality of side panels, comprising:
a rectangular epoxy-coated wire grid having a body portion and end portions, the body portion comprising a plurality of overlapping orthogonally oriented parallel wires and a central hinged area, and the end portions having captive terminations;
a plurality of support members having an internal cavity along a longitudinal axis and at least one engageable opening corresponding to the captive terminations, the engageable opening beginning at an external surface along the longitudinal axis and ending in the cavity, the support members being oriented horizontally and vertically such that the engageable opening aligns with and engages the captive terminations of the wire grid;
a pair of upper corners coupled to the upper proximal ends of the horizontal and vertical support members;
a pair of lower corners coupled to the lower proximal ends of the horizontal and vertical support members; and
a plurality of section connectors placed between the vertically oriented support members of adjacent side panels to couple the adjacent side panels together.

17. The animal enclosure system of claim 16 wherein at least one side panel further comprises a hingedly attached access panel.

18. The animal enclosure system of claim 17 wherein the end portions of the wire grid are captive terminated in bends having an angle of about 90 degrees in relation to the body portion of the wire grid and the engageable opening of the support members comprises a plurality of holes.

19. The animal enclosure system of claim 18 wherein the vertically oriented support members extend below the lower corners to touch a ground or floor surface such that the lower horizontally oriented support member is positioned above the ground or floor surface.
